(19) United States
(12) Patent Application Publication
(10) Pub. No.: US 2019/0251236 A1
(43) Pub. Date: Aug. 15, 2019

(54) BIOMETRIC DEVICE

(71) Applicant: Zwipe AS, Oslo (NO)

(72) Inventors: Peter Robert LOWE, Peyton, CO (US); Michelle ANDERSON, Colorado Springs, CO (US)

(21) Appl. No.: 15/895,132

(22) Filed: Feb. 13, 2018

(51) Int. Cl. G06F 21/32; G06F 21/34; G07F 7/10; G06K 9/00; H04L 9/32

(52) U.S. Cl. CPC G06F 21/32; G06F 21/34; H04L 9/3231; G06K 9/0002; G06K 9/00926; G07F 7/1008

(57) ABSTRACT

A biometric device such as a payment card includes a fingerprint sensor 15 having a sensing area for reading biometric data. A programming unit 1 is configured to engage the sensing area of the fingerprint sensor 15. The biometric device is configured to detect non-fingerprint data presented to the sensing area by the programming unit 1 and to process the non-fingerprint data as a command. Exemplary commands may cause the device to perform one or more of the following actions:
clear an enrolled biometric template stored on the device and/or permit enrolment of a new biometric template onto the device;
temporarily or permanently disable a biometric template stored on the device;
temporarily or permanently restrict one or more actions performable by the device;
modify one or more parameters of a biometric algorithm performable by the device, for example the algorithm may be a biometric matching algorithm and the parameter may be a similarity threshold for determining a match or a number of clock cycles per match;
modify a clock frequency of a processor in the device.

### TECHNICAL FIELD

The present disclosure relates to modification of the biometric data or biometric software stored on a biometrically-authenticated device.

### BACKGROUND

For a biometrically-authenticated smartcard intended for banking, the card may be physically assembled by various methods (examples include hot lamination, cold lamination and gluing). However, once the card has been fully assembled and thoroughly sealed, the only exposed contacts are at the contact pad for communication with the secure element. In particular, the electrodes of the electronic circuit that enable programing of the biometric authentication portion of the smartcard are hidden and cannot be accessed.

It is undesirable to modify the secure element to allow two-way communication with the biometric-authentication portion because of the stringent regulations applying to secure elements. This means that, if a change is necessary to the card firmware or the biometric data content of the card, then the card must be discarded and a new card used instead.

### SUMMARY

Viewed from a first aspect, the present disclosure provides a biometric device including a biometric sensor having a sensing area for reading biometric data, the device being configured to receive one or more predetermined, non-biometric pattern presented to the sensing area of the biometric sensor, to identify one or more command indicated by the one or more non-biometric pattern, and to perform an action in accordance with the one or more command.

The described device thus uses the biometric sensor for a dual purpose. Firstly (and primarily) the sensor is used for reading biometric data from a user, e.g. for enrolment purposes or in order to activate the device. Secondly, however, the sensor is also used for reading non-biometric patterns that are indicative of commands that are to be processed differently from the biometric data. The sensor can thus be used as an input to control the biometric sensor.

The biometric device is preferably a biometrically-authorisable device. The device preferably comprises a control system for controlling the device, wherein the control system is arranged to provide access to one or more functions of the device in response to detection of an authorised biometric presented to the biometric sensor. The control system may be further configured to process the one or more commands.

Various commands are possible, and the commands preferably affect a biometric processing portion of a control system of the device, i.e. they preferably do not affect non-biometric aspects of the device, such as the data or programs stored and operating in the secure elements and/or communications aspects of the device. For example, the command may cause the control system to modify stored biometric data and/or the algorithms used for processing the stored biometric data and/or scanned biometric data. Exemplary command may cause the device to perform one or more of the following actions:
clear an enrolled biometric template stored on the device and/or permit enrolment of a new biometric template onto the device.
temporarily or permanently disable a biometric template stored on the device.
temporarily or permanently restrict one or more actions performable by the device.
modify one or more parameters of a biometric algorithm performable by the device, for example the algorithm may be a biometric matching algorithm and the parameter may be a similarity threshold for determining a match or a number of clock cycles per match.
modify a clock frequency of a processor in the device.

The described device is not limited to any specific type of biometric sensor. In particular, those skilled in the art can select a suitable means for inputting the command to the sensor. However, in a preferred embodiment, the biometric sensor is a fingerprint sensor. The device may be configured to identify one or more predetermined patterns presented to the fingerprint sensor. The predetermined patterns are preferably non-fingerprint patterns.

The device may be configured to, responsive to identifying one of the one or more pre-stored patterns, process an input received via the biometric sensor in a different manner to biometric data. For example, the device may be configured to enter a programming mode in which data received from the biometric sensor is not processed as biometric data. For example, the device may, in the programming mode, be configured to receive binary data transmitted via the biometric sensor, e.g. as a serial data stream. That is to say, the command may be a command to enter a programming mode. Alternatively, the pre-stored patterns may themselves correspond to one or more commands to be executed, in which case the device may be configured to perform a corresponding action responsive to identifying one of the one or more pre-stored patterns.

In one example, the fingerprint sensor may be a capacitive fingerprint sensor. The sensor area of a capacitive fingerprint sensor comprises an array of capacitive elements and an electrode adjacent to the array of capacitive elements. The electrode, in normal use, is modulated by a high frequency voltage that couples to the skin of the user allowing the contours of the skin to be detected by the capacitive elements.

The one or more command may be supplied by a programming tool. Thus, in another aspect of the disclosure, there may be provided a tool for issuing one or more command to a biometric device comprising a capacitive fingerprint sensor having a driving electrode and an array of capacitive elements, the tool being shaped to engage the biometric device and comprising a first electrode positioned for engaging the driving electrode and an array of second electrodes positioned for capacitively coupling to the plurality of capacitive elements, the tool being configured to activate the second electrodes in one or more pre-determined, non-biometric pattern corresponding to one or more command.

As discussed above, the command may be a command to enter a programming mode. After which, the tool may be configured to transmit a signal to the biometric device via the electrodes. Alternatively, the command may be one of a plurality of predetermined commands to which the device is configured to respond.

The tool may comprise an input for receiving an indication of which command to transmit to the device. Alternatively, or additionally, the input may be configured for receiving data for transmission to the device.

In a further aspect of the disclosure, a kit of parts may be provided including a biometric device having a biometric sensor, such as described above, and a programming tool for issuing commands to the biometric device via a biometric sensing area of the biometric sensor, such as described above. The biometric device is preferably a portable device, by which is meant a device designed for being carried by a person, preferably a device small and light enough to be carried conveniently. For example, the device may have a volume of less than 100 cubic centimetres and/or a weight of less than 100 grams. The device can be arranged to be carried within a pocket, handbag or purse, for example.

The device may be a smartcard such as a fingerprint authorisable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the device is a smartcard then smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to fingerprint identification of an authorised user. Alternatively the control token may act as a remote locking type key, with the signal for unlocking the vehicle only being able to be sent if the fingerprint authorisation module identifies an authorised user. In this case the identification of the authorised user may have the same effect as pressing the unlock button on prior art keyless entry type devices, and the signal for unlocking the vehicle may be sent automatically upon fingerprint identification of an authorised user, or sent in response to a button press when the control token has been activated by authentication of an authorised user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

The device may include a biometric control system comprising a biometric processor for executing a biometric matching algorithm and a memory for storing biometric reference data. The control system of the device may include multiple processors, wherein the biometric processor may be a separate processor associated with the biometric sensor. Other processors of the control system and/or elsewhere on the device may include a control processor for controlling basic functions of the device, such as communication with other devices (e.g. via contactless technologies), activation and control of receivers/transmitters, activation and control of secure elements such as for financial transactions and so on. The various processors could be embodied in separate hardware elements, or could be combined into a single hardware element, possibly with separate software modules.

The device may be configured to perform both matching and enrolment scans using the same fingerprint sensor. As a result, scanning errors can be balanced out because, for example, if a user tends to present their finger with a lateral bias during enrolment, then they are likely to do so also during matching.

It is preferred for the device to be arranged so that it is impossible to extract the biometric data used for identifying users, for example a fingerprint template or the like. For example, although a command could be sent to disable a template, it is preferably not possible for a command to cause the device to actually transmit the template. The transmission of this type of data outside of the device is considered to be one of the biggest risks to the security of the device.

Viewed from a second aspect, the present disclosure also provides a method of interfacing with a biometric device including a biometric sensor having a sensing area for reading biometric data, the method comprising: presenting one or more pre-determined, non-biometric pattern to the sensing area of the biometric sensor, the more non-biometric pattern corresponding to one or more command, wherein the non-biometric pattern is processed differently from biometric data input via the sensing area the biometric sensor.

The biometric device is preferably a biometrically-authorisable device. The method may therefore also comprise inputting biometric data to the device via the sensing area of the biometric sensor, wherein a control system of the device provide access to one or more functions of the device in response to detection of authorised biometric data.

Various commands are possible, and the commands preferably affect a biometric processing portion of a control system of the device. For example, the method may comprise a control system of the biometric device modifying stored biometric data and/or the algorithms used for processing the stored biometric data and/or scanned biometric data, e.g. responsive to the one or more command. Exemplary commands may cause the device to perform one or more of the following actions:
clear an enrolled biometric template stored on the device and/or permit enrolment of a new biometric template onto the device.
temporarily or permanently disable a biometric template stored on the device.
temporarily or permanently restrict one or more actions performable by the device.
modify one or more parameters of a biometric algorithm performable by the device, for example the algorithm may be a biometric matching algorithm and the parameter may be a similarity threshold for determining a match or a number of clock cycles per match.
modify a clock frequency of a processor in the device.

The biometric sensor may be a fingerprint sensor. The method may comprise identifying by the device one or more predetermined patterns presented to the fingerprint sensor. The predetermined patterns are preferably non-fingerprint patterns.

The method may comprise, responsive to identifying one of the one or more pre-stored patterns, process an input received via the fingerprint sensor in a different manner to biometric data. For example, the device may enter a programming mode in which data received from the fingerprint sensor is not processed as biometric data. Alternatively, the pre-stored patterns may themselves correspond to the commands, in which case the device may perform a corresponding action responsive to identifying one of the one or more pre-stored patterns.

The one or more command may be supplied by a programming tool. The method may comprise engaging the tool with the biometric sensor of the biometric device. In one example, the fingerprint sensor may be a capacitive fingerprint sensor. The engaging may therefore comprise engaging a first electrode of the tool with a driving electrode of the device and capacitively coupling an array of second electrodes of the tool to a plurality of capacitive elements of the device.

The method may comprise supplying an indication to the tool of which command to transmit to the device and/or data for transmission to the device. The method may then comprise transmitting data and/or command to the device via the tool, i.e. via the sensing area of the device.

The device may be a device as described in the first aspect and/or may optionally comprise any of the preferred feature described above.

### DESCRIPTION OF THE DRAWINGS

Certain preferred embodiments of the present disclosure will now be described in greater detail by way of example only and with reference to the accompanying drawings, in which:

FIG. 1 illustrates a side and end view of a programming tool;

FIG. 2 illustrates the programming tool adjacent a biometric sensor of a biometrically-activated smartcard;

FIG. 3 illustrates the programming tool engaged with the biometric sensor of the biometrically-activated smartcard;

FIG. 4 shows an example biometrically-activated payment smartcard;

FIG. 5 illustrates a circuit for a biometrically-activated non-payment device; and

FIG. 6 shows an external housing of the non-payment device.

### DETAILED DESCRIPTION

For a biometrically authenticated smartcard 13 intended for banking using a secure element (not shown), it is desirable to be able to make certain changes in the card 13 once it has been fully assembled and thoroughly sealed. The card 13 may be physically assembled by one of several methods (examples being Hot Lamination, Cold Lamination or Gluing). In any case the card 13 cannot be disassembled in order to expose electrodes of the electronic circuits to enable programing of the biometric authentication engine 14.

The present card 13 uses the fingerprint sensor 15 to enable communication into the card 13, where the authenticating fingerprint sensor 15 is a fingerprint sensing pad of the capacitive type.

A capacitive fingerprint sensor comprises a sensor bezel 16 surrounding a sensing area 15. In normal use, a voltage is applied to the bezel 16 that is modulated at a high frequency, typically about 100 KHz, which couples into the skin of a user. The skin couples in turn to the sensor area 15 with greater or lesser amplitude according to the contours of the skin, i.e. the fingerprint. Sensor control electronics 14 scan the sensor area 15 in a raster pattern and read off the fingerprint pattern, which is directed to a microprocessor within the card 13.

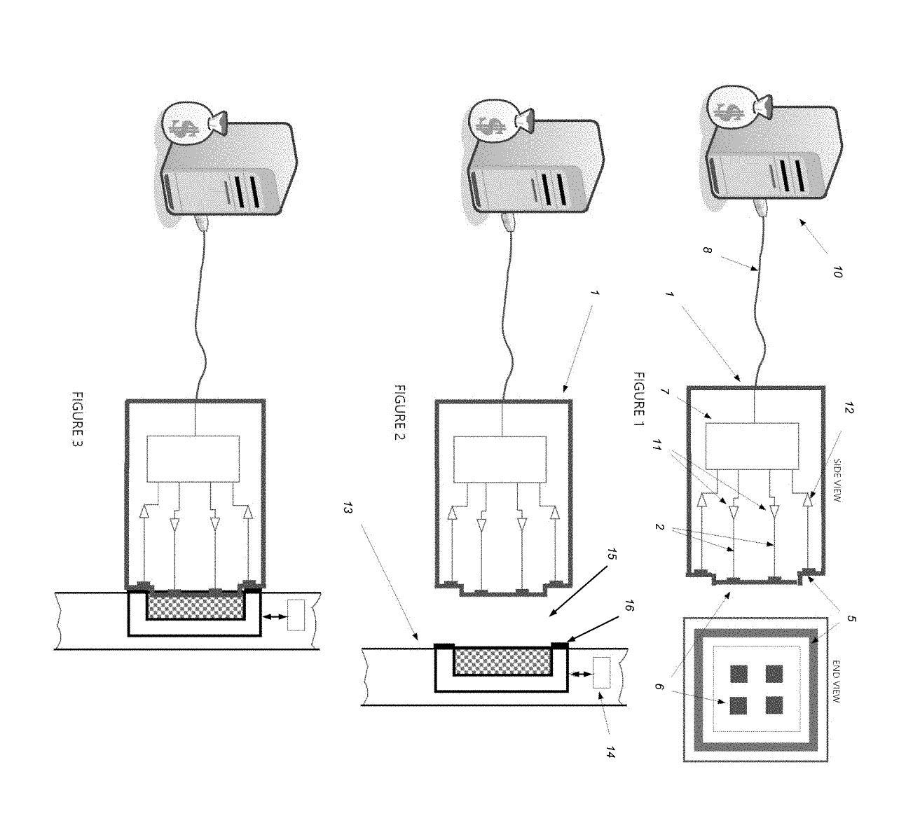

FIG. 1 shows a programming unit 1, which is physically a small plastic module with contacting features 5, 6 on one of its ends. Physically it fits intimately onto the fingerprint area 15 of the smartcard 13, not actually making ohmic contact with the sensor pad 15, but instead contacting the electrode areas 16 surrounding the sensor surface 15, such that signals can be sent and received by capacitive coupling.

There are two types of coupling electrodes 5, 6. The first electrodes 5 send signals to geometrically defined areas within the scanning area of the fingerprint sensor 15. They are connected through drive amplifiers 11 to the electronic element 7. The second coupling electrode 5 is a square ring and arranged to be adjacent to the bezel area 16 of the fingerprint sensor 15. It is connected through an amplifier 12 to the electronic element 7.

In order to have secure communication, it is necessary to allow both parties in the transaction send messages to the other. The present card 13 uses the fingerprint sensor 15 to facilitates messages from the programming unit 1 to the card 13, and makes use of the conductive metal bezel 16 (surrounding the sensing area of the fingerprint sensor 15) for sending messages from the card 13 to the programming unit 1.

The electronic element 7 is connected through cable 8 to a computer 10 on which an application runs. This application manages the messages which are sent to the card 13 once the programming unit 1 is engaged into the bezel area 16 of the biometric sensor 15.

The programming unit 1 does not have a fingerprint pattern but instead has electrodes 5 in the form of geometric shapes. These shapes may be quite arbitrary but must be in a predetermined pattern that the sensor electronics will recognize to be other than a fingerprint. Once a program operating in the microprocessor 5 on the card 13 identifies this unique pattern, it turns into a special programming mode and messaged go back and forth between the card 13 and the computer 10. The messaging may be cryptographically secure if a special unique key is programmed into the card 13 during manufacture into a place in memory where it may be secure. The transactions will then follow the protocol of symmetrical key encryption.

Whilst in the programming mode, there are several commands that it may be desirable to send to the card 13:

1) Re-enroll the card with a new template.

2) Lock the card down so it cannot be used until re-enabled.

3) Reconfigure firmware of the card, for example to change parameters in the Matching Algorithm e.g. the threshold, or to change the clock frequency or number of clock cycles per match to improve matching accuracy.

4) Lock a complete Template without the use of a live finger.

When the transaction is complete the computer 10 issues a special code which is recognized by the card 13 which then resumes normal operation.

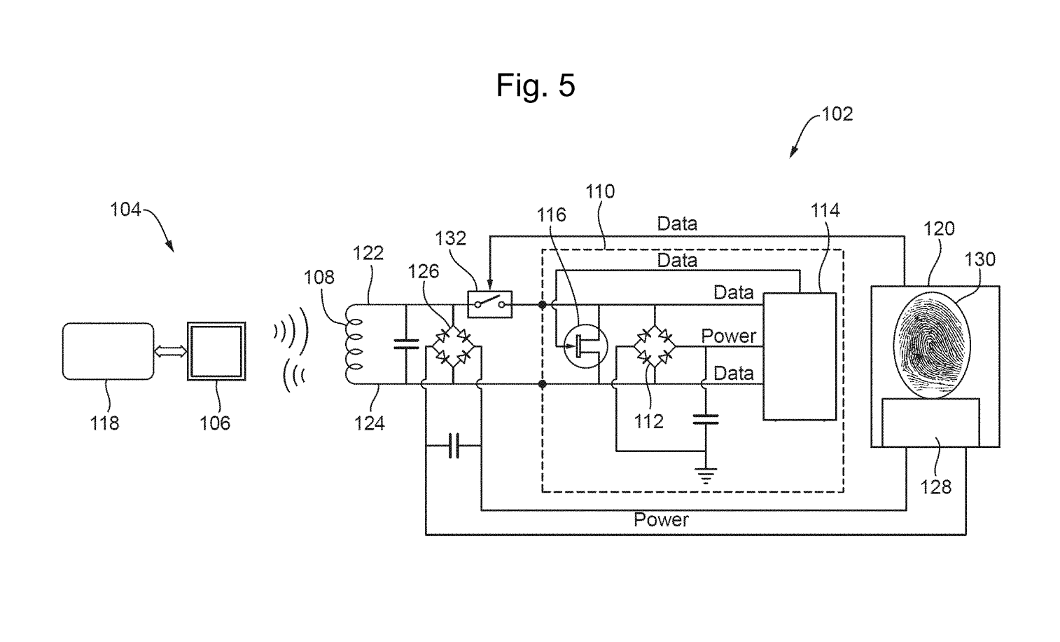

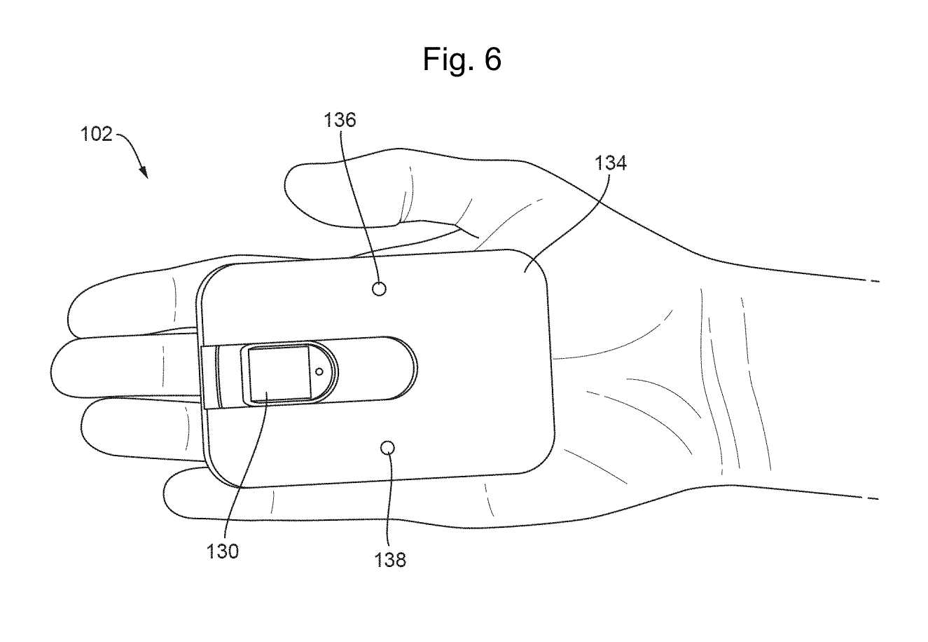

Whilst the above description relates to a biometrically-activated payment smartcard 13, the programming unit 1 may also be used with other biometrically-activated devices incorporating a capacitive type of fingerprint sensor. FIGS. 5 and 6 illustrate an exemplary a fingerprint authorised device 102 that may be used as an access card or the like. The terminals for reprogramming the device 102 are again not readily accessible after assembly, and so the device 102 may also benefits from the programming tool 1.

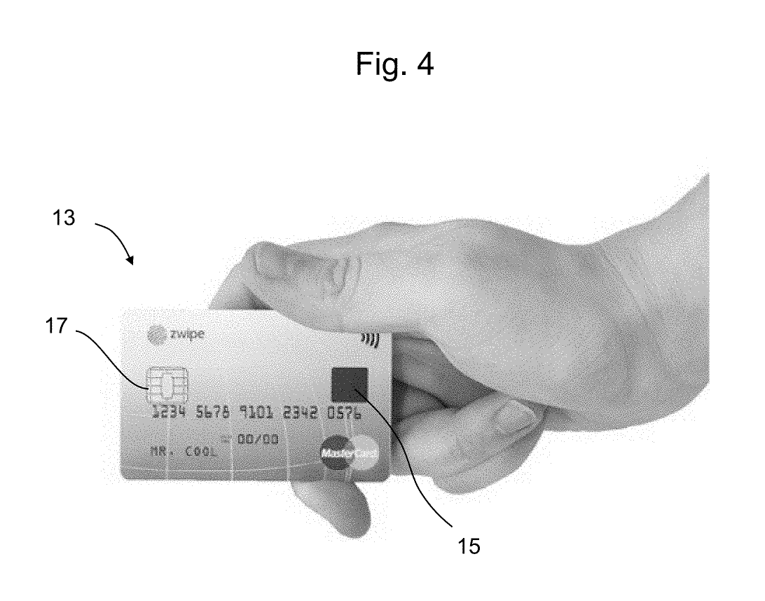

FIG. 4 shows the architecture of the biometrically-activated device 102. During normal operation, a powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the device 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the device 102 and decoded by suitable control circuits 118 in the sensor 104. This type of signalling is known as backscatter modulation and is characterised by the fact that the sensor 104 is used to power the return message to itself.

The device 102 further includes a fingerprint authentication engine 120 including a fingerprint processor 128 and the fingerprint sensor 130. This allows for enrolment and authorisation via fingerprint identification. The fingerprint processor 128 and the processor 114 that controls the communication chip 110 together form a control system for the device. The two processors could in fact be implemented as software modules on the same hardware, although separate hardware could also be used. The fingerprint sensor 130 may be used only when power is being harvested from the powered card reader 104, or alternatively the device 102 may be additionally provided with a battery allowing power to be provided at any time for the fingerprint sensor 130 and fingerprint processor 128, as well as the processor 114 and other features of the device.

The fingerprint authentication engine 120 is configured to operate in the same manner as described above. Thus, one or more commands may be issued to the fingerprint authentication engine 120 via the fingerprint sensor 130 using the programming tool 1.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120.

The fingerprint sensor 130 of the fingerprint authorisation engine, which is an area fingerprint sensor 130, may be mounted on a card housing 134 as shown in FIG. 6. However, the illustrated circuit may alternatively be formed as a laminated smartcard, similar to the payment card illustrated in FIG. 4, in which case the fingerprint sensor 130 may be fitted so as to be exposed from a laminated card body. The card housing 134 (or the laminated body) encases all of the components of the circuit 102 of FIG. 5, and is sized similarly to conventional smartcards.

The fingerprint authentication engine 120 can be passive, and hence powered only by the voltage output from the antenna 108, although the device 102 may also include a battery as mentioned above. A battery can power the fingerprint authentication engine 120 as well as other processors and user interfaces such as the LEDs 136, 138. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined, then the processor 128 takes appropriate action depending on its programming. In this example the fingerprint authorisation process is used to authorise the use of the device 102 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136.

The processor 114 has an enrolment mode, which may be activated upon first use of the device 102. In the enrolment mode the user is prompted to enrol their fingerprint data via the fingerprint sensor 130. This can require a repeated scan of the fingerprint via the fingerprint sensor 130 so that the fingerprint processor 128 can build up appropriate fingerprint data, such as a fingerprint template.

The illustrated device 102 uses contactless technology and power harvested from the antenna 108. These features are envisaged to be advantageous features of one device 102 compatible with the proposed programming device 1, but are not seen as essential features. The device 102 may hence alternatively or additionally use a physical contact interface and/or include a battery providing internal power, for example.

The programming device 1 can also be implemented in combination with appropriate modifications in any other device or system that uses similar biometric authorisation. Furthermore, those skilled in the art will appreciate that the programming device 1 may be adapted to provide a signal to alternative forms of biometric sensor.

1. A biometric device including a biometric sensor having a sensing area for reading biometric data, the device being configured to receive one or more predetermined, non-biometric pattern presented to the sensing area of the biometric sensor, to identify one or more command indicated by the one or more non-biometric pattern, and to perform an action in accordance with the one or more command.

2. A biometric device according to claim 1, wherein the biometric device is a biometrically-authorisable device arranged to provide access to one or more functions of the device in response to detection of an authorised biometric presented to the biometric sensor.

3. A biometric device according to claim 1, wherein the one or more command affects a biometric processing portion of a control system of the device, such as modifying stored biometric data and/or modifying algorithms used for processing biometric data.

4. A biometric device according to claim 1, wherein the one or more command includes at least one of:
a command to cause the device to permit enrolment of a new biometric template onto the device;
a command to cause the device to clear an enrolled biometric template stored on the device;
a command to cause the device to temporarily or permanently disable a biometric template stored on the device;
a command to cause the device to temporarily or permanently restrict one or more actions performable by the device;
a command to cause the device to modify one or more parameters of a biometric algorithm performable by the device;
a command to cause the device to modify a clock frequency of a processor in the device.

5. A device according to claim 1, wherein the device is arranged so that it will not transmit biometric data used for identifying users.

6. A biometric device according to claim 1, wherein the biometric device is a portable device.

7. A biometric device according to claim 1, wherein the device is a smartcard.

8. A biometric device according to claim 1, wherein the biometric sensor is a fingerprint sensor.

9. A biometric device according to claim 8, wherein the fingerprint sensor is a capacitive fingerprint sensor having an array of capacitive elements and a driving electrode adjacent to the array of capacitive elements.

10. A programming tool for issuing one or more command to a biometric device comprising a capacitive fingerprint sensor having a driving electrode and an array of capacitive elements, the tool being shaped to engage the biometric device and comprising a first electrode positioned for engaging the driving electrode and an array of second electrodes positioned for capacitively coupling to the plurality of capacitive elements, the tool being configured to activate the second electrodes in one or more pre-determined, non-biometric pattern corresponding to the one or more command.

11. A programming tool according to claim 10, wherein the tool comprises an input for receiving an indication of which command to transmit to the biometric device and/or for receiving data for transmission to the biometric device.

12. A kit comprising a programming tool according to claim 10 and a biometric device including a biometric sensor having a sensing area for reading biometric data, the device being configured to receive one or more predetermined, non-biometric pattern presented to the sensing area of the biometric sensor, to identify one or more command indicated by the one or more non-biometric pattern, and to perform an action in accordance with the one or more command.

13. A method of interfacing with a biometric device including a biometric sensor having a sensing area for reading biometric data, the method comprising:
presenting one or more pre-determined, non-biometric pattern to the sensing area of the biometric sensor, the more non-biometric pattern corresponding to one or more command, wherein the non-biometric pattern is processed differently from biometric data input via the sensing area the biometric sensor.

14. A method according to claim 13, comprising:
inputting biometric data to the device via the sensing area of the biometric sensor, wherein a control system of the device provides access to one or more functions of the device in response to detection of authorised biometric data.

15. A method according to claim 13, comprising:
modifying, by a control system of the biometric device, biometric data stored on the device and/or the algorithms stored on the device for processing biometric data responsive to the one or more command.

16. A method according to any of claims 13, wherein the one or more command causes the device to:
clear an enrolled biometric template stored on the device;
permit enrolment of a new biometric template onto the device;
temporarily or permanently disable a biometric template stored on the device;
temporarily or permanently restrict one or more actions performable by the device;
modify one or more parameters of a biometric algorithm performable by the device; and
modify a clock frequency of a processor in the device
